(19) United States
(12) Patent Application Publication
(10) Pub. No.: US 2023/0259810 A1
(43) Pub. Date: Aug. 17, 2023

(54) Domain Adapting Framework for Anomalous Detection

(71) Applicant: Robert Bosch GmbH, Stuttgart (DE)

(72) Inventors: Bingqing Chen, Pittsburgh, PA (US); Luca Bondi, Pittsburgh, PA (US); Samarjit Das, Sewickley, PA (US)

(21) Appl. No.: 17/669,872

(22) Filed: Feb. 11, 2022

(51) Int. Cl. G06N 20/00

(52) U.S. Cl. CPC G06N 20/00

(57) ABSTRACT

A computer-implemented system and method includes obtaining a plurality of tasks from a first domain. A machine learning system is trained to perform a first task. A first set of prototypes is generated. The first set of prototypes is associated with a first set of classes of the first task. The machine learning system is updated based on a first loss output. The first loss output includes a first task loss, which takes into account the first set of prototypes. The machine learning system is trained to perform a second task. A second set of prototypes is generated. The second set of prototypes is associated with a second set of classes of the second task. The machine learning system is updated based on a second loss output. The second loss output includes a second task loss, which takes into account the second set of prototypes. The machine learning system is updated based on the second loss output. The machine learning system is fine-tuned with a new task from a second domain.

### FIELD

This disclosure relates generally to machine learning systems, and more particularly to domain shift adaptation and anomaly detection.

### BACKGROUND

In general, anomaly detection involves identifying anomalous observations. Although there have been a number of recent advances in anomaly detection, there is still some uncertainty with respect to how existing solutions with deep learning methods would perform under out-of distribution scenarios. As an illustrative example, for instance, anomaly detection may be used to monitor industrial equipment via audio data. During such acoustic condition monitoring, there may be some uncertainty as to how existing solutions would be able to identify anomalous observations in industrial equipment under various out-of distribution scenarios, such as when there are shifts in machine load or when there is environmental noise.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method for domain adaptation includes obtaining a plurality of tasks from a first domain. The plurality of tasks include at least a first task and a second task. A machine learning system is trained to perform the first task. The method includes generating a first set of prototypes associated with a first set of classes of the first task. The method includes optimizing a first loss output that includes a first task loss. The first task loss is computed based on the first set of prototypes. The method includes updating the machine learning system based on the first loss output. The method includes training the machine learning system to perform the second task. The method includes generating a second set of prototypes associated with a second set of classes of the second task. The method includes optimizing a second loss output that includes a second task loss. The second task loss is computed based on the second set of prototypes. The method includes updating the machine learning system based on the second loss output. The method includes obtaining a new task from a second domain, which is distinct from the first domain. The method includes fine-tuning the machine learning system with the new task.

According to at least one aspect, one or more non-transitory computer readable storage media stores computer readable data with instructions that when executed by one or more processors cause the one or more processors to perform a method for domain adaptation. The method includes obtaining a plurality of tasks from a first domain. The plurality of tasks include at least a first task and a second task. The method includes training a machine learning system to perform a first task. The method includes generating a first set of prototypes associated with a first set of classes of the first task. The method includes optimizing a first loss output that includes a first task loss. The first task loss is computed based on the first set of prototypes. The method includes updating the machine learning system based on the first loss output. The method includes training the machine learning system to perform a second task. The method includes generating a second set of prototypes associated with a second set of classes of the second task. The method includes optimizing a second loss output that includes a second task loss. The second task loss is computed based on the second set of prototypes. The method includes updating the machine learning system based on the second loss output. The method includes obtaining a new task from a second domain. The method includes fine-tuning the machine learning system with the new task.

According to at least one aspect, a computer-implemented method for domain adaptation includes obtaining a first task from a plurality of tasks in a source domain. The first task includes a first support set and a first query set. The method includes generating, via a machine learning system, first support output in response to the first support set. The method includes generating a first set of prototypes for each class of the first task using the first support output. The method includes generating, via the machine learning system, first query output in response to the first query set. The method includes computing a first loss output. The first loss output includes at least a first task loss. The first task loss is computed based on the first set of prototypes and the first query output. The method includes updating a parameter of the machine learning system based on the first loss output. The method includes training the machine learning system with respect to remaining tasks of the plurality of tasks. The method includes fine-tuning the machine learning system with a few-shot examples from a new task in a target domain.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is a diagram of an example of a system relating to domain shift adaptation according to an example embodiment of this disclosure.

FIG. 2 is a conceptual diagram that illustrates aspects associated with the technical problem of adapting the machine learning system to new conditions according to an example embodiment of this disclosure.

FIG. 3 is a conceptual diagram that illustrates aspects associated with the training phase according to an example embodiment of this disclosure.

FIG. 4 is a conceptual diagram that illustrates aspects associated with the inference phase according to an example embodiment of this disclosure.

FIG. 5 is a conceptual diagram that illustrates few-shot classification according to an example embodiment of this disclosure.

FIG. 6 is a conceptual diagram that illustrates aspects of at least a portion of a domain adaptation process, which includes multi-objective meta-learning according to an example embodiment of this disclosure.

FIG. 7 depicts a schematic diagram of an interaction between a computer-controlled machine and a control system according to an example embodiment of this disclosure.

FIG. 8 depicts a schematic diagram of the control system of FIG. 7 that is configured to control a mobile machine, which is at least partially or fully autonomous, according to an example embodiment of this disclosure.

FIG. 9 depicts a schematic diagram of the control system of FIG. 7 that is configured to control a manufacturing machine of a manufacturing system, such as part of a production line, according to an example embodiment of this disclosure.

FIG. 10 depicts a schematic diagram of the control system of FIG. 7 that is configured to control a power tool having at least a partially autonomous mode according to an example embodiment of this disclosure.

FIG. 11 depicts a schematic diagram of the control system of FIG. 7 that is configured to control an automated personal assistant according to an example embodiment of this disclosure.

FIG. 12 depicts a schematic diagram of the control system of FIG. 7 that is configured to control a monitoring system according to an example embodiment of this disclosure.

FIG. 13 depicts a schematic diagram of the control system of FIG. 7 that is configured to control a medical imaging system according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

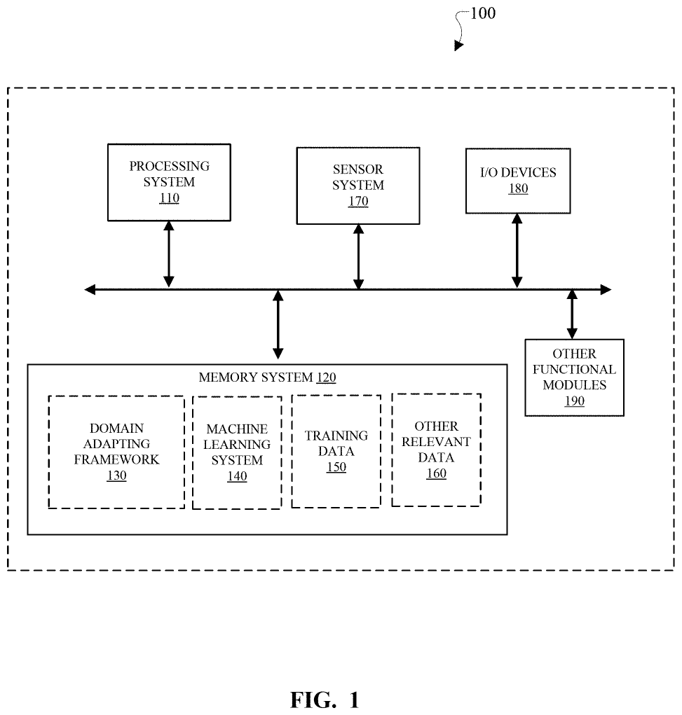

FIG. 1 is a diagram of a non-limiting example of a system 100, which is configured to train, employ, and/or deploy at least one machine learning system 140 according to an example embodiment. The system 100 includes at least a processing system 110 with at least one processing device. For example, the processing system 110 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 110 is operable to provide the functionality as described herein.

The system 100 includes a memory system 120, which is operatively connected to the processing system 110. In an example embodiment, the memory system 120 includes at least one non-transitory computer readable storage medium, which is configured to store and provide access to various data to enable at least the processing system 110 to perform the operations and functionality, as disclosed herein. In an example embodiment, the memory system 120 comprises a single memory device or a plurality of memory devices. The memory system 120 may include electrical, electronic, magnetic, optical, semiconductor, electromagnetic, or any suitable storage technology that is operable with the system 100. For instance, in an example embodiment, the memory system 120 can include random access memory (RAM), read only memory (ROM), flash memory, a disk drive, a memory card, an optical storage device, a magnetic storage device, a memory module, any suitable type of memory device, or any number and combination thereof. With respect to the processing system 110 and/or other components of the system 100, the memory system 120 is local, remote, or a combination thereof (e.g., partly local and partly remote). For instance, in an example embodiment, the memory system 120 includes at least a cloud-based storage system (e.g. cloud-based database system), which is remote from the processing system 110 and/or other components of the system 100.

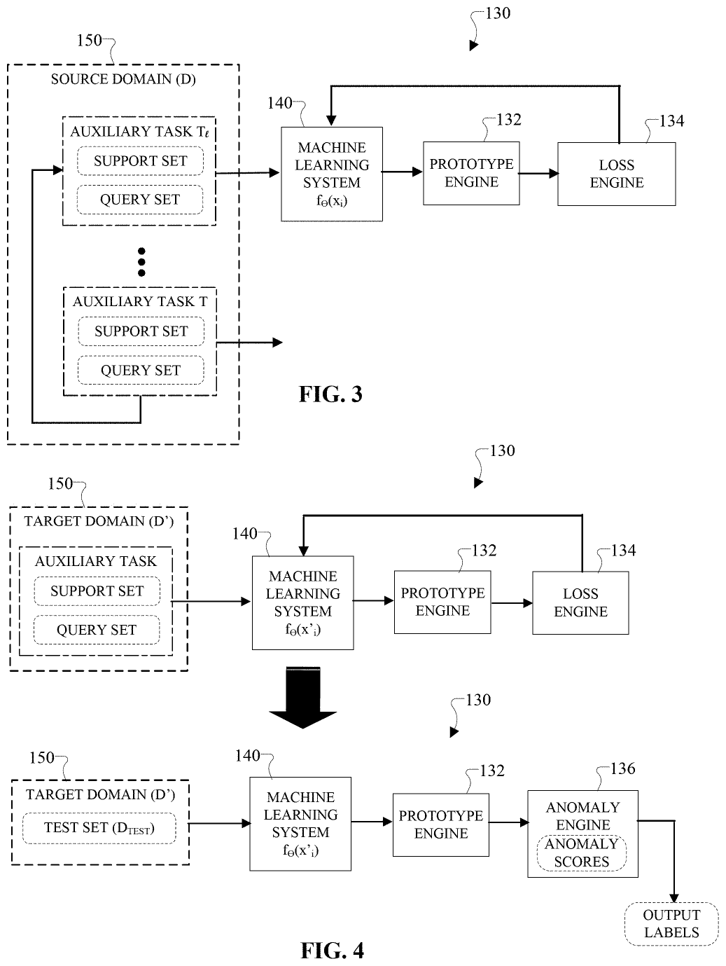

The memory system 120 includes at least a domain adapting framework 130, the machine learning system 140, training data 150, and other relevant data 160, which are stored thereon. The domain adapting framework 130 includes computer readable data with instructions, which, when executed by the processing system 110, is configured to adapt one or more machine learning systems 140 from one domain (e.g., “source domain”) to another domain (e.g., target domain”). The computer readable data can include instructions, code, routines, various related data, any software technology, or any number and combination thereof. In an example embodiment, as shown in FIG. 3 and FIG. 4, the domain adapting framework 130 includes a prototype engine 132, a loss engine 134, and an anomaly engine 136. In this regard, the term, “engine,” may refer to a software-based system, subsystem, or process, which is programmed to perform one or more specific functions. An engine may include one or more software modules or software components, which are stored in the memory system 120 at one or more locations. In some cases, the engine may also include one or more hardware components. The domain adapting framework 130 is not limited to these engine components but may include more or less engine components provided that the domain adapting framework 130 is configured to provide the functionalities as described herein.

In an example embodiment, the machine learning system 140 includes a convolutional neural network (CNN), any suitable encoding network, any suitable artificial neural network model, or any number and combination thereof. Also, the training data 150 includes at least a sufficient amount of sensor data, timeseries data, dataset data from a number of domains, few-shot examples, few-shot samples, various loss data (e.g., various loss output data, various task loss data, various outlier loss data, etc.), various weight data, and various parameter data, as well as any related machine learning data that enables the system 100 to provide the domain adapting framework 130, as described herein. Meanwhile, the other relevant data 160 provides various data (e.g. operating system, machine learning algorithms, anomaly score data, etc.), which enables the system 100 to perform the functions as discussed herein.

The system 100 is configured to include at least one sensor system 170. The sensor system 170 includes one or more sensors. For example, the sensor system 170 includes an image sensor, a camera, a radar sensor, a light detection and ranging (LIDAR) sensor, a thermal sensor, an ultrasonic sensor, an infrared sensor, a motion sensor, an audio sensor, an inertial measurement unit (IMU), any suitable sensor, or any number and combination thereof. The sensor system 170 is operable to communicate with one or more other components (e.g., processing system 110 and memory system 120) of the system 100. For example, the sensor system 170 may provide sensor data, which is then used or pre-processed by the processing system 110 to generate suitable input data (e.g., audio data, image data, etc.) for the machine learning system 140. In this regard, the processing system 110 is configured to obtain the sensor data directly or indirectly from one or more sensors of the sensor system 170. The sensor system 170 is local, remote, or a combination thereof (e.g., partly local and partly remote). Upon receiving the sensor data, the processing system 110 is configured to process this sensor data and provide the sensor data in a suitable format (e.g., audio data, image data, etc.) in connection with the domain adapting framework 130, the machine learning system 140, the training data 150, or any number and combination thereof.

In addition, the system 100 may include at least one other component. For example, as shown in FIG. 1, the memory system 120 is also configured to store other relevant data 160, which relates to operation of the system 100 in relation to one or more components (e.g., sensor system 170, input/output (I/O) devices 180, and other functional modules 190). In addition, the system 100 is configured to include one or more I/O devices 180 (e.g., display device, keyboard device, microphone device, speaker device, etc.), which relate to the system 100. Also, the system 100 includes other functional modules 190, such as any appropriate hardware, software, or combination thereof that assist with or contribute to the functioning of the system 100. For example, the other functional modules 190 include communication technology that enables components of the system 100 to communicate with each other as described herein. In this regard, the system 100 is operable to at least train, employ, and/or deploy the machine learning system 140 (and/or the domain adapting framework 130), as described herein.

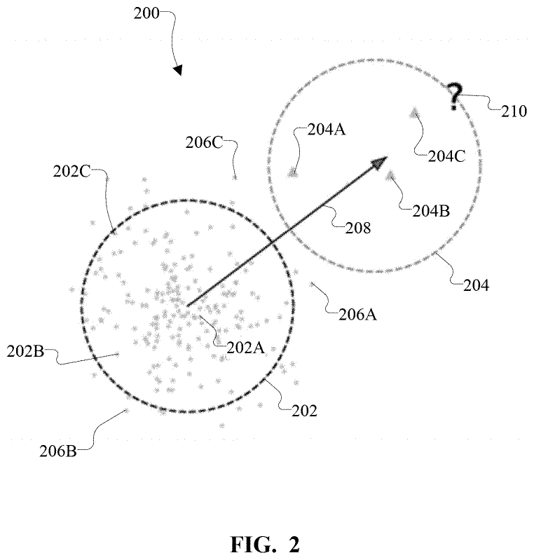

FIG. 2 is a conceptual diagram that illustrates the technical problem of adapting the machine learning system 140 to new conditions. More specifically, FIG. 2 illustrates a data space 200 that includes a source domain 202 (denoted as D) and a target domain 204 (denoted as D′). The source domain 202 includes a set of data, which may serve as input to the machine learning system 140. The target domain 204 includes another set of data, which may serve as input to the machine learning system 140. Also, FIG. 2 illustrates a circle to represent a boundary of a particular domain such that anything on or within an area of the circle represents in-domain data (e.g., data that is within a scope of the particular task) whereas anything outside of that same circle represents out-of-domain data (or data that is outside the scope of that particular task). For instance, in the non-limiting example shown in FIG. 2, the source domain 202 has a sufficient amount of samples, which include at least data element 202A, data element 202B, and data element 202C, as well as many other samples as represented by each dot within the bounds of the source domain 202. In contrast, the target domain 204 includes a few-shot samples, which include data element 204A, data element 204B, and data element 204C. In FIG. 2, the few-shot samples are represented as triangles. In this case, the target domain 204 includes three data samples, but may include any suitable number of few-shot samples. Meanwhile, FIG. 2 also shows a number of other samples, such as data element 206A, data element 206B, data element 206C, and several other samples, which are outside the scope and bounds of both the source domain 202 and the target domain 204.

FIG. 2 also illustrates an arrow 208 to represent a domain shift from the source domain 202 to the target domain 204. In general, it is not desirable for an observation to be tagged as anomalous when there is a change in conditions. For instance, with respect to acoustic condition monitoring of an industrial machine, a change of conditions may include a change in machine load, background noise, etc. For example, this scenario may occur when the machine learning system 140 is trained with a sufficient amount of data in the first domain (i.e., the source domain 202), and then later transitions to new conditions or a second domain (i.e., the target domain 204). To overcome this technical problem, the domain adapting framework 130 is configured to provide a technical solution that enables the machine learning system 140 to adapt to the new conditions using only a handful of samples or only a few-shot samples in that target domain 204. Also, in FIG. 2, the question mark 210 represents a new or unseen observation, which the machine learning system 140 receives as input data during inference time and which the anomaly engine 136 determines is anomalous or non-anomalous upon comparing an anomaly score to one or more thresholds.

With respect to anomaly detection, the domain adapting framework 130 defines the distribution of normal data as [symbol] * over the data space X∈ [symbol] ^{D} which anomalies may be characterized as the set of samples that unlikely come from [symbol] *, i.e. [symbol] ={x∈X| [symbol] *(x)≤α}, where α is a threshold that controls a Type I error. In this regard, a Type I error refers to misclassifying normal (i.e. non-anomalous) samples as being anomalous, which may occur as the variability within normal data can be relatively large. Also, a fundamental assumption in anomaly detection is the concentration assumption, i.e. the region where normal data resides can be bounded. More precisely, there exists α≥0, such that X\ [symbol] ={x∈X| [symbol] *(x)>α} is nonempty and small. This assumption does not require the support of [symbol] * be bounded; only that the support of the high-density region of [symbol] * be bounded. In contrast, anomalies need not be concentrated and a commonly-used assumption is that anomalies follow a uniform distribution over X.

As an overview, the domain adapting framework 130 adopts a classification-based approach for anomaly detection and show its equivalence to mixture density estimation of the normal samples. The domain adapting framework 130 is configured for level sets of the distribution, and classification-based methods that learn decision boundaries and delineate high density and low-density regions. The domain adapting framework 130 incorporates an episodic training procedure to match the few-shot setting during inference. The domain adapting framework 130 defines multiple auxiliary classification tasks based on meta-information and leverages gradient-based meta-learning to improve generalization to different shifts. More specially, in an example embodiment, the domain adapting framework 130 is configured to perform a number of operations, as indicated in the following algorithm.

Algorithm

| | |
|---|---|
| 1: | input: Data [symbol] , [symbol] ′; Test set [symbol] ₜₑₛₜ; Model f_{θ}: |
| 2: | parameter: Learning rate ∝ Outer step-size e, Number |
| | of inner and fine-tuning inerations T and Tₜₑₛₜ |
| 2: | function COMPUTELOSS( [symbol] , Q, I) |
| 3: | // input: support set, query set, task index |
| 4: | // Compute protarypes from the support set |
| 5: | ${c}_{k} = \frac{1}{\vert 𝒮 \text{?} \vert} \sum \text{?} {f}_{s} ( {x}_{i} ) , ∀ h$ |
| 6: | // Calculate task loss from the query set |
| 7. | $return \frac{1}{\vert Q \vert} \sum \text{?} ℒ \text{?} ( {x}_{i} , {y}_{i} ; θ )$ |
| 7: | end function |
| 8. | |
| 8: | procedure TRAIN(f_{θ}, [symbol] ) |
| 9: | // input: model, training data |
| 10: | initialize θ |
| 11: | while not done do |
| 12: | for [symbol] ₗ [symbol] [symbol] do |
| 13: | set θ⁽⁰⁾ = θ |
| 14: | for t = 0, . . . , T − 1 do |
| 15: | [symbol] , Q~ [symbol] // Sample support and query set |
| 16: | [symbol] _{T}_{ᵢ} = COMPUTELOSS( [symbol] , Q, l) |
| 17: | update θ^{(t+λ)} = θ^{(t)} − α∇ₒ [symbol] _{T}_{ᵢ} (θ^{(t)}) |
| 18: | end for |
| 19: | meta update θ ← θ + ϵ [θ^{(T)} − θ] |
| 20: | end for |
| 21: | end while |
| 21: | end procedure |
| 22. | |
| 22: | procedure INFERENCE(f [symbol] , [symbol] ′, [symbol] ₜₑₛₜ) |
| 23: | // input: trained model, few-shot examples, test set |
| 24: | set θ⁽⁰⁾ = θ^{x} |
| 25: | // Fine-tuning on few-shot examples |
| 26: | for t = 0, . . . , T [symbol] − 1 do |
| 27: | [symbol] _{T}_{₀} = COMPUTELOSS( [symbol] ′, [symbol] ′, 0) |
| 28: | update θ^{(t+1)} = θ^{(t)} − α∇₀ [symbol] _{T}_{₀} (θ^{(t)}) |
| 29: | end for |
| 30: | // Compute [symbol] score for test samples |
| 31: | compute Ω [symbol] (xᵢ, yᵢ), ∀(xᵢ, yᵢ)~ [symbol] ₜₑₛₜ |
| 31. | end procedure = 0 |

[symbol]

indicates data missing or illegible when filed

The domain adapting framework 130 obtains a dataset from the source domain D={(xᵢ, yᵢ)}, where each xᵢ∈ [symbol] ^{D} is a normal sample and yᵢ∈ [symbol] ^{L} are the labels for auxiliary classification tasks. The domain adapting framework 130 also obtains a relatively small number of samples in the target domain D′={(x′ᵢ, yᵢ}, where each x′ᵢ∈ [symbol] ^{D} is a normal sample from a domain-shifted condition. In this regard, there may be scenarios in which the domain adapting framework 130 only has access to normal samples in both the source domain and the target domain. Each auxiliary task is denoted as T₁ and the set of L of auxiliary tasks as T={T₁, . . . , T_{L}}. The domain adapting framework 130 uses the machine learning system 140, which includes an artificial neural network model, to map samples from the data space to an embedding space. The artificial neural network model may be represented as f_{θ}: [symbol] ^{D}→ [symbol] ^{d}, where D>>d. The embedding, which corresponds to each sample, is denoted as zᵢ, where zᵢ=f_{θ}(xᵢ)∈ [symbol] ^{d}, and the distribution of the normal data in the embedding space is denoted as [symbol] _{z}*. Furthermore, as indicated in the algorithm, the domain adapting framework 130 includes at least a training phase and an inference phase.

FIG. 3 is a conceptual diagram that illustrates the training phase according to an example embodiment. As aforementioned, the domain adapting framework 130 includes training the machine learning system 140 with a set L of auxiliary tasks from a source domain. Each auxiliary task is different from the other auxiliary tasks. By being trained on each auxiliary task from the set L of auxiliary tasks, the domain adapting framework 130 (e.g., the machine learning system 140) is configured to perform a main task. As indicated in the algorithm, the domain adapting framework 130 is configured to train the machine learning system 140 with each auxiliary task for several iterations or a plurality of times. Each auxiliary task is associated with and relates to the main task.

As a non-limiting example, for instance, the main task includes determining whether or not sensor data (e.g., audio data) is anomalous. For example, when applied to machine condition monitoring, the domain adapting framework 130 is configured to develop an anomalous sound detection system (ASD) that performs a main task of determining if sensor data (e.g. audio data) obtained from an industrial machine is an anomalous sound while monitoring a condition (the “health”) of that industrial machine. In this regard, for example, the domain adapting framework 130 may use various sensor data (e.g., audio data) and corresponding metadata to train the machine learning system 140 to perform several auxiliary tasks. More specifically, the audio data serves as input data for the machine learning system 140 while the metainformation or metadata serves as ground truth data for the machine learning system 140. For instance, if the industrial machine includes a gearbox, then the machine learning system 140 may be trained to perform (i) an auxiliary task of classifying audio data that relates to a voltage of the gearbox in which the classes include various voltages, (ii) an auxiliary task of classifying audio data that relates to arm length of the gearbox in which the classes include various arm lengths, (iii) an auxiliary task of classifying audio data that relates to a weight of the gearbox in which the classes include various weights, and so forth until the machine learning system 140 is trained with each auxiliary task a number of times. The number of classes for these auxiliary tasks may differ such that, as non-limiting examples, there may be three classes for voltages, five classes for arm lengths, and eight classes for weights. Each of these auxiliary tasks contribute to teaching the machine learning system 140 to determine whether audio data from the gearbox is anomalous, for example, with respect to damaged gear sounds, overloaded gearbox sounds, and over-voltage gearbox sounds.

In addition, the domain adapting framework 130 includes an episodic training procedure such that the training condition matches the test condition. For example, for each auxiliary task, the domain adapting framework 130 is configured to create an episode and generate a support set (denoted as S) and a query set (denoted as Q). In this regard, the domain adapting framework 130 is configured to split each mini-batch into a support set and a query set. The support set includes a number of samples from a dataset associated with the selected task from the source domain. The query set includes a number of other samples from that same dataset of that same selected task of that same source domain. In this regard, the support set is different from the query set. For instance, each sample of the support set may be different from each sample of the query set. During the training phase, the support set simulates the few-shot examples, and the query set simulates the test samples. Also, with respect to a single auxiliary task T₁, the machine learning system 140 is configured to generate a class label 1, . . . , K, where K represents a total number of class labels and is an integer number greater than 1. In addition, the domain Dₖ is represented as Dₖ={(xᵢ, yᵢ)∈D|yᵢ=k}. Also, one auxiliary task may have a different number of total class labels (K) than another auxiliary task within the set L of auxiliary tasks from the source domain.

At a given time during the training phase, the machine learning system 140 is trained to perform a given auxiliary task. For the given auxiliary task, the machine learning system 140 generates support output in response to the support set. Also, for the given auxiliary task, the machine learning system 140 generates query output in response to the query set. The machine learning system 140 is configured to provide the support output and the query output to the prototype engine 132 and the loss engine 134.

The prototype engine 132 generates prototypes for each class of the given task. In this regard, for example, the prototype engine 132 is configured to generate K prototypes for K classes for the given auxiliary task. The value of K may differ for different auxiliary tasks. As non-limiting examples, for instance, one auxiliary task may include 5 classes, another auxiliary class may include 3 classes, and yet another auxiliary task may include 12 classes. As indicated in the algorithm, each prototype includes a class centroid cₖ, as expressed in equation 1. More specifically, as indicated in the algorithm, the prototype engine 132 generates a prototype via equation 1 using the support set Sₖ such that a class centroid is computed for every class k.

$${c}_{k} = \frac{1}{[ {D}_{k} ]} {\sum }_{( {x}_{i} , {y}_{i} ) ∼ {D}_{k}} {f}_{θ} ( {x}_{i} , ) \qquad [ 1 ]$$

The domain adapting framework 130 is configured to provide a classification objective (e.g., equation 5), which is equivalent to mixture density estimation on normal samples. More specifically, as an explanation, in deep support vector data description (SVDD), there is an assumption that the neural network can find a latent representation such that the majority of normal points fall within a single hypersphere or equivalently [symbol] _{z}* follows an isotropic Gaussian distribution. Based on similar or the same intuition, the domain adapting framework 130 relaxes this assumption and model [symbol] _{z}* with a mixture model, as expressed in equation 2, where π is the prior distribution for class membership. As an example, an industrial machine (which the anomaly engine 136 is detecting whether or not there is an anomaly or defect) may operate normally under different operating loads. Instead of assuming that normal data can be modeled by a single cluster, the distribution of normal data can be better characterized with a number of clusters each corresponding to an operating load. With this more flexible representation, the domain adapting framework 130 enables the machine learning system 140 (e.g., artificial neural network model) to learn fine-granular features conducive to anomaly detection, and extrapolate better to unseen scenarios, e.g. another operating load.

[symbol]

_{z}*(z)=Σₖ₌₁^{K}πₖ [symbol] (z|y=k) [2]

The domain adapting framework 130 also characterizes [symbol] (z|y=k) by a distribution in the exponential family, as expressed in equation 3, where d is a Bregman divergence. The choice of d dictates the modeling assumption on the conditional distribution, [symbol] (z|y). For instance, by choosing squared Euclidean distance, i.e., d(z, cₖ)=∥z−cₖ∥₂², then each cluster is modeled as an isotropic Gaussian. Given these modeling assumptions, then equation 4 can be rewritten as equation 5, by assuming a flat prior on class membership, which can be trivially satisfied by sampling mini-batches with balanced classes. This shows that learning the auxiliary classification task is equivalent to performing mixture density estimation with exponential family, where each cluster corresponds to a class. The learning objective is to maximize the log-likelihood of assigning each sample to its correct class, or equivalently minimizing the negative log-likelihood as in equation 5.

$$ℙ ( z \vert y = k ) α exp ( - d ( z , {c}_{k} ) ) \qquad [ 3 ]$$

$${ℙ}_{θ} ( y = k \vert {x}_{i} ) = \frac{{π}_{k} exp ( - d ( {f}_{θ} ( {x}_{i} ) , {c}_{k} ) )}{{\sum }_{{k}^{′}} {π}_{{k}^{′}} exp ( - d ( {f}_{θ} ( x ) , {c}_{{k}^{′}} ) )} \qquad [ 4 ]$$

$${L}_{τ l} ( {x}_{i} , {y}_{i} ; θ ) = - log \frac{exp ( - d ( {f}_{θ} ( {x}_{i} ) , {c}_{y i} ) )}{{\sum }_{k} exp ( - d ( {f}_{θ} ( x ) , {c}_{k} ) )} \qquad [ 5 ]$$

In addition, as shown in FIG. 3, the loss engine 134 is configured to compute a loss output for the machine learning system 140 and update one or more parameters of the machine learning system 140 based on the loss output. More specifically, as indicated in the algorithm, the loss engine 134 is configured to compute the loss output using the query set Q. As one example, for instance, the loss engine 134 is configured to compute a prototype loss L_{ProtoNet} according to equation 6, as indicated in the algorithm. Also, the prototype loss L_{ProtoNet} accounts for a task loss L_{τl}, as expressed in equation 5, where d is a distance metric.

$${L}_{ProtoNet} = \frac{1}{\vert Q \vert} {\sum }_{( {x}_{i} , {y}_{i} ) ∼ Q} {L}_{τ l} ( {x}_{i} , {y}_{i} ; θ ) \qquad [ 6 ]$$

Alternatively, as another example, for instance, the loss engine 134 is configured to compute a loss output based on equation 7. In this regard, the loss engine 134 is configured to compute a loss output (equation 7) that is based on a combination of the prototype loss L_{ProtoNet}(equation 6) and an outlier exposure loss L_{OE} (equation 8). The outlier exposure loss L_{OE} is computed according to equation 8. The outlier exposure loss L_{OE}, which is based on an outlier exposure technique, is configured to boost performance. It may be assumed that anomalies follow a uniform distribution over the data space. In this regard, the outlier exposure loss L_{OE} is defined as cross-entropy to the uniform distribution and added to the learning objective with weight λ.

$$L = {L}_{P r o t o N e t} + λ {L}_{OE} \qquad [ 7 ]$$

$${L}_{O E} ( {x}_{i} , θ ) = {\sum }_{y = 1}^{k} log \frac{exp ( - d ( {f}_{θ} ( {x}_{i} ) , {c}_{y} ) )}{{\sum }_{j = 1}^{k} exp ( - d ( {f}_{θ} ( {x}_{i} ) , {c}_{j} )} \qquad [ 8 ]$$

So far, the above discussion focused on a single auxiliary classification task. However, as shown in FIG. 3, there may be more metainformation regarding operating conditions available. Since the samples may be subject to different changes due to operating condition, machine load, or environment noise, the domain adapting framework 130 trains the machine learning system 140 on a variety of tasks. This training enables the machine learning system 140 to be conducive to learning salient feature that generalizes well to different domain shifts. Also, it is not known a priori which auxiliary classification task would be most effective for anomaly detection. Thus, it is sensible to train on all auxiliary classification tasks available from the metainformation. Empirically, the domain adapting framework 130 has shown that training on all auxiliary classification tasks does outperform training on any single auxiliary classification task.

In general, meta-learning trains the model on a distribution of auxiliary tasks such that it can quickly learn a new, unseen auxiliary task with few-shot samples. Thus, these auxiliary classification tasks can be naturally incorporated into meta-learning algorithms. There are connections, which may be drawn between multi-task learning and meta-learning. However, as a distinction, meta-learning typically trains on different tasks of the same nature, e.g., 5-way image classification, whereas multi-task learning may train on functionally related tasks of different nature, e.g. image reconstruction and classification. The domain adapting framework 130 includes an approach, which falls under the latter case and which is different from typical meta-learning problems. For example, the domain adapting framework 130 is configured to use a first-order variant of model-agnostic metalearning (MAML), which learns parameter initialization that can be fine-tuned quickly on a new task. For example, the machine learning system 140 repeatedly samples a task Tₗ˜T, trains on that task, and moves at least one model parameter towards the trained weights on that task following an update of one or more model parameters, as indicated in the algorithm and equation 9, where θ^{(T)} represents at least one model parameter after training on Tₗ for T gradient steps and ∈ is step-size for meta-update. Also, the domain adapting framework 130 is configured to simultaneously minimize expected loss over all tasks and maximize within-task generalization. In this regard, the domain adapting framework 130 takes a gradient step on one minibatch to improve performance on another minibatch.

θ←θ+∈[θ^{(T)}−θ] [9]

FIG. 4 is a conceptual diagram that illustrates the inference phase with a first segment and a second segment according to an example embodiment. In the first segment, as shown in FIG. 4, the machine learning system 140 performs an auxiliary task from the target domain. This auxiliary task relates to and/or supports the main task of anomaly detection. In this regard, the domain adapting framework 130 is configured to obtain or generate a support set and a query set based on the few-shot examples, which are associated with the auxiliary task of the target domain.

During this first segment, the machine learning system 140 performs the auxiliary task of the target domain. This auxiliary task of the target domain may be a new task or a known task from the set L of auxiliary tasks. In particular, the machine learning system 140 generates few-shot output in response to the few-shot examples for the support set and the query set of the target domain. The machine learning system 140 is configured to provide the few-shot output to the prototype engine 132 and the loss engine 134. The few-shot output includes class labels associated with the auxiliary task of the target domain.

The prototype engine 132 is configured to generate a prototype for each class of the auxiliary task of the target domain. In general, the domain adapting framework 130 includes a few-shot learning method that classifies samples based on distance on the embedding space. In this regard, during inference, the prototype engine 132 uses the few-shot output to establish the new class centroid (i.e. prototype) under domain-shifted conditions, cₖ′, as indicated in equation 10.

$${c}_{k}^{′} = \frac{1}{[ {D}_{k}^{′} ]} {\sum }_{{( {x}_{i}^{′} , {y}_{i}^{′} ) \sim D )}_{k}^{′}} {f}_{θ} ( {x}_{i}^{′} ) \qquad [ 10 ]$$

In addition, the loss engine 134 is configured to compute a loss output for the few shot examples. The loss engine 134 is configured to update one or more of the parameters of the machine learning system 140 based on that loss output associated with the target domain. The loss engine 134 is configured to compute the loss output according to equation 6 or equation 7. In addition, the loss engine 134 is configured to update one or more parameters of the machine learning system 140 based on the loss output.

As indicated in the algorithm, the domain adapting framework 130 is configured to perform a number (denoted as Tₜₑₛₜ) of fine-tuning iterations on the machine learning system 140 using the few-shot examples as input. In this case, Tₜₑₛₜ represents a value greater than 1. In this regard, the domain adapting framework 130 is based on auxiliary classification in which the machine learning system 140 is trained to differentiate between classes, either defined via metadata inherent to the dataset or synthesized by applying various transformations to the sample and calculate the anomaly score as the negative log-likelihood of a sample belonging to the correct class.

During the second segment, the machine learning system 140 generates sample output data in response to the sample input data. For example, the test set (Dₜₑₛₜ) includes the test samples or sample input data, which are obtained or generated from the target domain. Also, as shown in FIG. 4, the domain adapting framework 130 includes an anomaly engine 136. With the anomaly engine 136, the domain adapting framework 130 is configured to compute an anomaly score Ω_{θ} for every sample (xᵢ, yᵢ) of the test set (Dₜₑₛₜ) via equation 11, where xᵢ, represents the sample input data and yᵢ represents the sample output data. Upon computing an anomaly score Ω_{θ} for a sample, the domain adapting framework 130 is configured to determine if that sample is an anomaly by comparing the anomaly score to a threshold. Based on the comparison, the anomaly engine 136 is configured to generate an output label, which indicates whether or not that particular sample is determined to be anomalous or non-anomalous. For example, the output label may include a first output label that is used as an anomalous indicator and a second output label that is used as a non-anomalous indicator (e.g., normal indicator).

Ω_{θ}(xᵢ,yᵢ)=−log [symbol] _{θ}(y=yᵢ|xᵢ) [11]

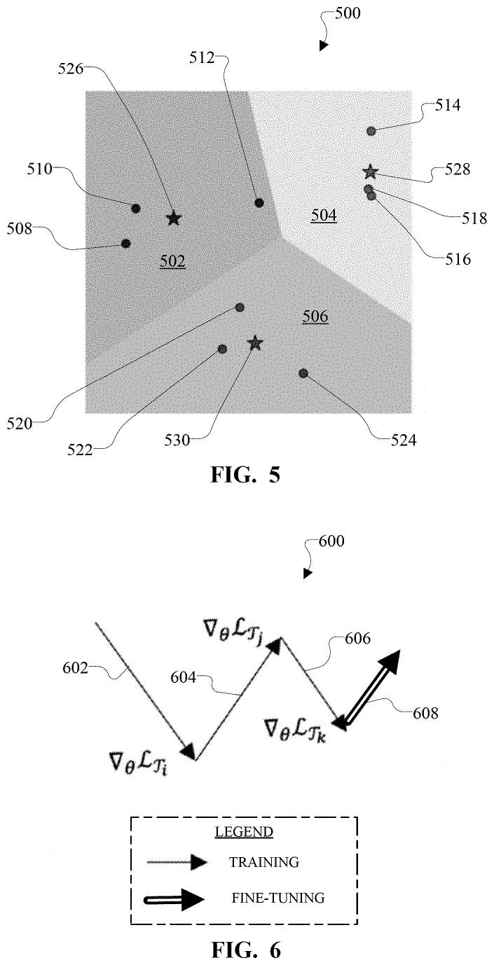

FIG. 5 is a conceptual diagram that illustrates few-shot classification according to an example embodiment. More specifically, for anomaly detection, the domain adapting framework 130 adopts a classification-based approach based on distance with respect to the embedding space. The domain adapting framework 130 leverages an episodic training procedure to match the few-shot (e.g., 3-shot) setting during inference. In this regard, FIG. 5 shows a visualization of a predetermined number of classes with respect to an embedding space 500. These classes are associated with a selected auxiliary task. FIG. 5 also shows each class as being defined by its boundaries. For instance, as a non-limiting example, FIG. 5 shows three classes, which include a first class 502, a second class 504, and a third class 506. FIG. 5 also shows a number of few-shot data in each class. For example, the first class 502 includes a first sample 508, a second sample 510, and a third sample 512. The second class 504 includes a first sample 514, a second sample 516, and a third sample 518. The third class 506 includes a first sample 520, a second sample 522, and a third sample 524. In addition, as aforementioned, the domain adapting framework 130 is configured to generate a prototype for each class. In this case, for example, each prototype represents an average of the few-shot data of each class. Each prototype is a class centroid and computed using equation 1 for the source domain (or equation 10 for the target domain). More specifically, for instance, the domain adapting framework 130 generates a first prototype 526 for the first class 502, a second prototype 528 for the second class 504, and a third prototype 530 for the third class 506. These features are advantageous in establishing a basis for optimizing the loss output and updating the machine learning system 140.

FIG. 6 is a conceptual diagram that illustrates a visualization of at least a part of a process 600 for domain adaptation that includes multi-objective meta-learning according to an example embodiment. As non-limiting examples, the process 600 includes at least (i) one training phase 602 that includes training and updating the machine learning system 140 based on one task (task (ii) a subsequent training phase 604 that includes training and updating the machine learning system 140 based on a subsequent task (Tⱼ), (iii) another subsequent training phase 606 that includes training and updating the machine learning system 140 based on another subsequent task (Tₖ), and so forth until the machine learning system 140 is trained and updated based on each auxiliary task of the set L of auxiliary tasks for a number of iterations. In addition, the process 600 also includes a fine-tuning phase 608 that includes fine tuning the machine learning system 140 based on an auxiliary task in the target domain. As shown in FIG. 6, each training phase includes a loss function L, which is multiplied by a gradient ∇_{θ}. The gradient ∇_{θ} is multiplied by the loss function L given by the different tasks (e.g., Tᵢ, Tⱼ, and Tₖ) to provide a result, which is used to update one or more model parameters (e.g., theta) of the machine learning system 140. In this regard, FIG. 6 illustrates the concept of alternating between multiple auxiliary classification objectives to improve generalization to different shifts.

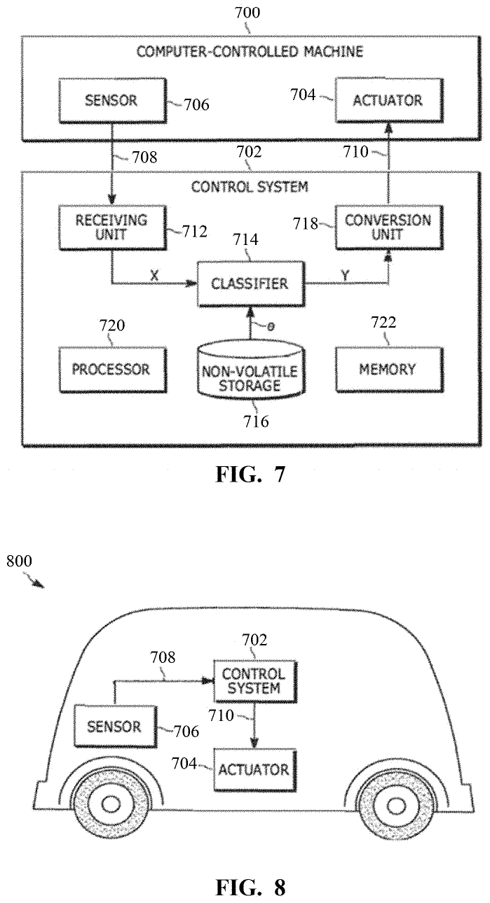

FIG. 7 depicts a schematic diagram of an interaction between computer-controlled machine 700 and control system 702. Computer-controlled machine 700 includes actuator 704 and sensor 706. Actuator 704 may include one or more actuators and sensor 706 may include one or more sensors. Sensor 706 is configured to sense a condition of computer-controlled machine 700. Sensor 706 may be configured to encode the sensed condition into sensor signals 708 and to transmit sensor signals 708 to control system 702. A non-limiting example of sensor 706 includes video, radar, LiDAR, an ultrasonic sensor, an image sensor, an audio sensor, a motion sensor, etc. In some embodiments, sensor 706 is an optical sensor configured to sense optical images of an environment proximate to computer-controlled machine 700.

Control system 702 is configured to receive sensor signals 708 from computer-controlled machine 700. As set forth below, control system 702 may be further configured to compute actuator control commands 710 depending on the sensor signals and to transmit actuator control commands 710 to actuator 704 of computer-controlled machine 700.

As shown in FIG. 7, control system 702 includes receiving unit 712. Receiving unit 712 may be configured to receive sensor signals 708 from sensor 706 and to transform sensor signals 708 into input signals x. In an alternative embodiment, sensor signals 708 are received directly as input signals x without receiving unit 712. Each input signal x may be a portion of each sensor signal 708. Receiving unit 712 may be configured to process each sensor signal 708 to product each input signal x. Input signal x may include data corresponding to an image recorded by sensor 706.

Control system 702 includes classifier 714. Classifier 714 may be configured to classify input signals x into one or more labels using a machine learning (ML) algorithm via employing the trained machine learning system 140 (FIG. 1). Classifier 714 is configured to be parametrized by parameters, such as those described above (e.g., parameter θ). Parameters θ may be stored in and provided by non-volatile storage 716. Classifier 714 is configured to determine output signals y from input signals x. Each output signal y includes information that assigns one or more labels to each input signal x. Classifier 714 may transmit output signals y to conversion unit 718. Conversion unit 718 is configured to covert output signals y into actuator control commands 710. Control system 702 is configured to transmit actuator control commands 710 to actuator 704, which is configured to actuate computer-controlled machine 700 in response to actuator control commands 710. In some embodiments, actuator 704 is configured to actuate computer-controlled machine 700 based directly on output signals y.

Upon receipt of actuator control commands 710 by actuator 704, actuator 704 is configured to execute an action corresponding to the related actuator control command 710. Actuator 704 may include a control logic configured to transform actuator control commands 710 into a second actuator control command, which is utilized to control actuator 704. In one or more embodiments, actuator control commands 710 may be utilized to control a display instead of or in addition to an actuator.

In some embodiments, control system 702 includes sensor 706 instead of or in addition to computer-controlled machine 700 including sensor 706. Control system 702 may also include actuator 704 instead of or in addition to computer-controlled machine 700 including actuator 704. As shown in FIG. 7, control system 702 also includes processor 720 and memory 722. Processor 720 may include one or more processors. Memory 722 may include one or more memory devices. The classifier 714 (i.e., the trained machine learning system 140) of one or more embodiments may be implemented by control system 702, which includes non-volatile storage 716, processor 720, and memory 722.

Non-volatile storage 716 may include one or more persistent data storage devices such as a hard drive, optical drive, tape drive, non-volatile solid-state device, cloud storage or any other device capable of persistently storing information. Processor 720 may include one or more devices selected from high-performance computing (HPC) systems including high-performance cores, graphics processing units, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 722. Memory 722 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 720 may be configured to read into memory 722 and execute computer-executable instructions residing in non-volatile storage 716 and embodying one or more ML algorithms and/or methodologies of one or more embodiments. Non-volatile storage 716 may include one or more operating systems and applications. Non-volatile storage 716 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 720, the computer-executable instructions of non-volatile storage 716 may cause control system 702 to implement one or more of the ML algorithms and/or methodologies to employ the trained machine learning system 140 as disclosed herein. Non-volatile storage 716 may also include ML data (including model parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. Furthermore, the processes, methods, or algorithms can be embodied in whole or in part using suitable hardware components, such as ASICs. FPGAs, state machines, controllers or other hardware components or devices, or a combination of hardware, software and firmware components.

FIG. 8 depicts a schematic diagram of control system 702 configured to control vehicle 800, which may be at least a partially autonomous vehicle or a partially autonomous robot. Vehicle 800 includes actuator 704 and sensor 706. Sensor 706 may include one or more video sensors, cameras, radar sensors, ultrasonic sensors, LiDAR sensors, and/or position sensors (e.g. Global Positioning System). One or more of the one or more specific sensors may be integrated into vehicle 800. Alternatively or in addition to one or more specific sensors identified above, sensor 706 may include a software module configured to, upon execution, determine a state of actuator 704. One non-limiting example of a software module includes a weather information software module configured to determine a present or future state of the weather proximate to the vehicle 800 or at another location.

Classifier 714 of control system 702 of vehicle 800 may be configured to detect objects in the vicinity of vehicle 800 dependent on input signals x. In such an embodiment, output signal y may include information classifying or characterizing objects in a vicinity of the vehicle 800. Actuator control command 710 may be determined in accordance with this information. The actuator control command 710 may be used to avoid collisions with the detected objects.

In some embodiments, the vehicle 800 is an at least partially autonomous vehicle or a fully autonomous vehicle. The actuator 704 may be embodied in a brake, a propulsion system, an engine, a drivetrain, a steering of vehicle 800, etc. Actuator control commands 710 may be determined such that actuator 704 is controlled such that vehicle 800 avoids collisions with detected objects. Detected objects may also be classified according to what classifier 714 deems them most likely to be, such as pedestrians, trees, any suitable labels, etc. The actuator control commands 710 may be determined depending on the classification.

In some embodiments where vehicle 800 is at least a partially autonomous robot, vehicle 800 may be a mobile robot that is configured to carry out one or more functions, such as flying, swimming, diving and stepping. The mobile robot may be a lawn mower, which is at least partially autonomous, or a cleaning robot, which is at least partially autonomous. In such embodiments, the actuator control command 710 may be determined such that a propulsion unit, steering unit and/or brake unit of the mobile robot may be controlled such that the mobile robot may avoid collisions with identified objects.

In some embodiments, vehicle 800 is an at least partially autonomous robot in the form of a gardening robot. In such embodiment, vehicle 800 may use an optical sensor as sensor 706 to determine a state of plants in an environment proximate to vehicle 800. Actuator 704 may be a nozzle configured to spray chemicals. Depending on an identified species and/or an identified state of the plants, actuator control command 710 may be determined to cause actuator 704 to spray the plants with a suitable quantity of suitable chemicals.

Vehicle 800 may be a robot, which is at least partially autonomous and in the form of a domestic appliance. As a non-limiting example, a domestic appliance may include a washing machine, a stove, an oven, a microwave, a dishwasher, etc. In such a vehicle 800, sensor 706 may be an optical sensor configured to detect a state of an object which is to undergo processing by the household appliance. For example, in the case of the domestic appliance being a washing machine, sensor 706 may detect a state of the laundry inside the washing machine. Actuator control command 710 may be determined based on the detected state of the laundry.

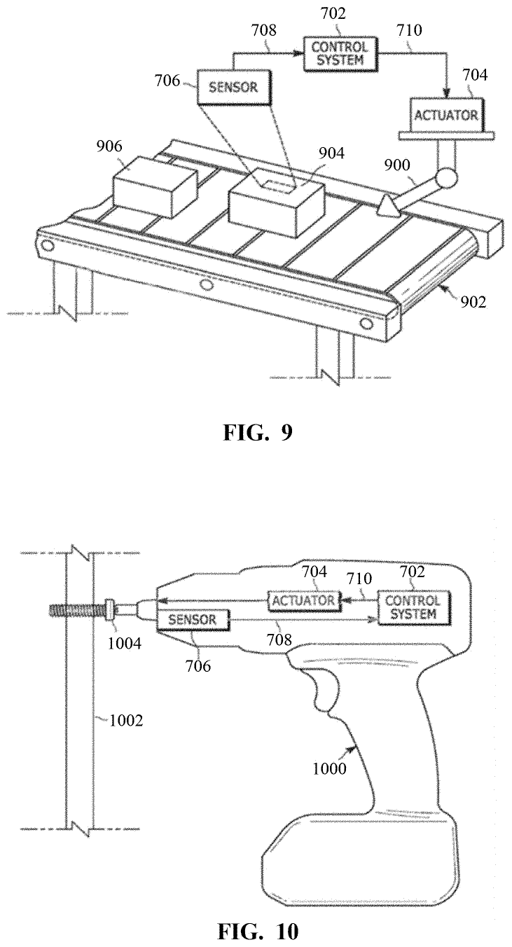

FIG. 9 depicts a schematic diagram of control system 702 configured to control a system 900 (e.g., manufacturing machine), which may include a punch cutter, a cutter, a gun drill, or the like, of a manufacturing system 902, such as part of a production line. Control system 702 may be configured to control actuator 704, which is configured to control the system 900 (e.g., manufacturing machine).

Sensor 706 of the system 900 (e.g., manufacturing machine) may be an optical sensor configured to capture one or more properties of a manufactured product 904. Classifier 714 may be configured to determine a state of manufactured product 904 from one or more of the captured properties. Actuator 704 may be configured to control the system 900 (e.g., manufacturing machine) depending on the determined state of a manufactured product 904 for a subsequent manufacturing step of the manufactured product 904. The actuator 704 may be configured to control functions of the system 900 (e.g., manufacturing machine) on a subsequent manufactured product 906 of system 900 (e.g., manufacturing machine) depending on the determined state of manufactured product 904.

FIG. 10 depicts a schematic diagram of control system 702, which is configured to control power tool 1000. As a non-limiting example, the power tool 1000 may be a power drill or a driver, which has at least a partially autonomous mode. Control system 702 may be configured to control actuator 704, which is configured to control the power tool 1000.

Sensor 706 of power tool 1000 may be an optical sensor configured to capture one or more properties of work surface 1002 and/or fastener 1004 being driven into work surface 1002. Classifier 714 may be configured to determine a state of work surface 1002 and/or fastener 1004 relative to work surface 1002 from one or more of the captured properties. The state may be fastener 1004 being flush with work surface 1002. The state may alternatively be hardness of work surface 1002. Actuator 704 may be configured to control power tool 1000 such that the driving function of power tool 1000 is adjusted depending on the determined state of fastener 1004 relative to work surface 1002 or one or more captured properties of work surface 1002. For example, actuator 704 may discontinue the driving function if the state of fastener 1004 is flush relative to work surface 1002. As another non-limiting example, actuator 704 may apply additional or less torque depending on the hardness of work surface 1002.

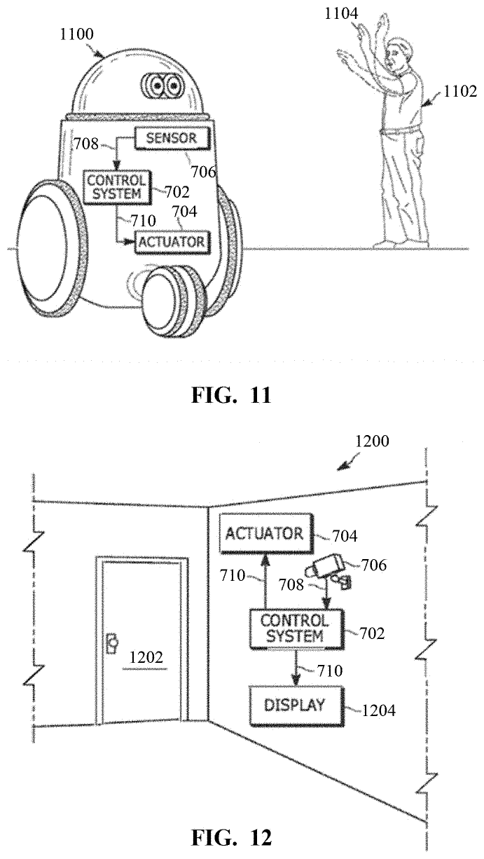

FIG. 11 depicts a schematic diagram of control system 702 configured to control automated personal assistant 1100. Control system 702 may be configured to control actuator 704, which is configured to control automated personal assistant 1100. Automated personal assistant 1100 may be configured to control a domestic appliance, such as a washing machine, a stove, an oven, a microwave, a dishwasher, or the like. Sensor 706 may be an optical sensor and/or an audio sensor. The optical sensor may be configured to receive video images of gestures 1104 of user 1102. The audio sensor may be configured to receive a voice command of user 1102.

Control system 702 of automated personal assistant 1100 may be configured to determine actuator control commands 710 configured to control system 702. Control system 702 may be configured to determine actuator control commands 710 in accordance with sensor signals 708 of sensor 706. Automated personal assistant 1100 is configured to transmit sensor signals 708 to control system 702. Classifier 714 of control system 702 may be configured to execute a gesture recognition algorithm to identify gesture 1104 made by user 1102, to determine actuator control commands 710, and to transmit the actuator control commands 710 to actuator 704. Classifier 714 may be configured to retrieve information from non-volatile storage in response to gesture 1104 and to output the retrieved information in a form suitable for reception by user 1102.

FIG. 12 depicts a schematic diagram of control system 702 configured to control monitoring system 1200. Monitoring system 1200 may be configured to physically control access through door 1202. Sensor 706 may be configured to detect a scene that is relevant in deciding whether access is granted. Sensor 706 may be an optical sensor configured to generate and transmit image and/or video data. Such data may be used by control system 702 to detect a person's face.

Classifier 714 of control system 702 of monitoring system 1200 may be configured to interpret the image and/or video data by matching identities of known people stored in non-volatile storage 716, thereby determining an identity of a person. Classifier 714 may be configured to generate an actuator control command 710 in response to the interpretation of the image and/or video data. Control system 702 is configured to transmit the actuator control command 710 to actuator 704. In this embodiment, the actuator 704 is configured to lock or unlock door 1202 in response to the actuator control command 710. In some embodiments, a non-physical, logical access control is also possible.

Monitoring system 1200 may also be a surveillance system. In such an embodiment, sensor 706 may be an optical sensor configured to detect a scene that is under surveillance and the control system 702 is configured to control display 1204. Classifier 714 is configured to determine a classification of a scene, e.g. whether the scene detected by sensor 706 is suspicious. Control system 702 is configured to transmit an actuator control command 710 to display 1204 in response to the classification. Display 1204 may be configured to adjust the displayed content in response to the actuator control command 710. For instance, display 1204 may highlight an object that is deemed suspicious by classifier 714.

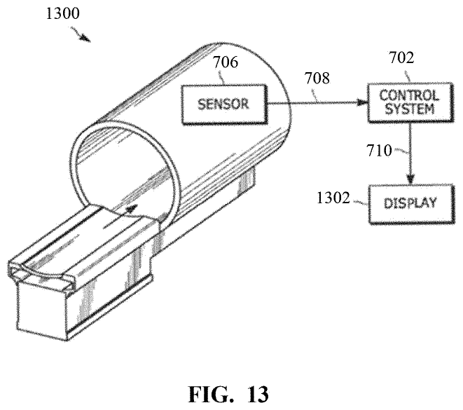

FIG. 13 depicts a schematic diagram of control system 702 configured to control imaging system 1300, for example a magnetic resonance imaging (MRI) apparatus, x-ray imaging apparatus or ultrasonic apparatus. Sensor 706 may, for example, be an imaging sensor. Classifier 714 may be configured to determine a classification of all or part of the sensed image. Classifier 714 may be configured to determine or select an actuator control command 710 in response to the classification obtained by the trained neural network. For example, classifier 714 may interpret a region of a sensed image to be potentially anomalous. In this case, the actuator control command 710 may be selected to cause display 1302 to display the image and highlight the potentially anomalous region.

As described in this disclosure, the embodiments provide a number of advantages and benefits. For example, the domain adapting framework 130 deals with the challenging task of adapting an unsupervised machine learning system 140 to new conditions using few-shot samples. To achieve this objective, the domain adapting framework 130 is configured to train a classification-based machine learning system 140 with an episodic procedure to match the few-shot setting during inference. The domain adapting framework 130 uses a gradient-based meta-learning algorithm to find parameter initialization that can quickly adapt to new conditions with gradient-based updates. Also, the domain adapting framework 130 is configured to boost the machine learning system 140, e.g., the artificial neural network model, with outlier exposure. The domain adapting framework 130 is configured to penalize cases in which the machine learning system 140 is prone to strongly assign an outlier sample to a class, which it shouldn't be assigned.

In addition, the domain adapting framework 130 is configured to develop the machine learning system 140 for anomaly detection using only normal (i.e., non-anomalous) samples. This feature is advantageous as there are a number of challenges with respect to enumerating potential anomalous conditions and generating anomalous samples. Also, the domain adapting framework 130 is configured to define multiple auxiliary classification tasks based on meta-information while leveraging gradient-based meta-learning to improve generalization to different shifts.

The domain adapting framework 130 may be used in various applications to provide domain adaptation based on few-shot samples. In this regard, various fields and applications can benefit from being able to extend a capability of a machine learning model to operate effectively in a first domain in which there is sufficient training data and also in a second domain in which there is a very limited amount of training data. For instance, as a non-limiting example, when there is a change in one sensor to another sensor of the same type (e.g., upgrading one image sensor to another image sensor for enhanced images), there may be some shifts/variations in the sensor data that will be input into the machine learning system 140 based upon the change of sensors. Advantageously, the domain adapting framework 130 combats these domain shifts/variations and ensures that the machine learning system 140 operates accurately in each of the domains. In this regard, the domain adapting framework 130 contributes to building robust distributed software.

Furthermore, as discussed above, the domain adapting framework 130 may be applied to anomaly detection. For instance, the domain adapting framework 130 may develop an ASD system, which is configured to utilize existing knowledge to adapt to new conditions relatively quickly. In this regard, the domain adapting framework 130 is configured to constrain the machine learning system 140 to learn with only a handful of normal observations from the new conditions. For example, the ASD system may be used to monitor machine health via one or more audio signals. The ASD system may include at least the trained machine learning 140 and the anomaly engine 136, as shown in FIG. 4. In this regard, detecting anomalies is useful for identifying incipient machine faults, condition-based maintenance, and quality assurance. Compared to direct measurements for determining anomalies, the ASD system is advantageous in leveraging non-anomalous audio data to be cost-effective, non-intrusive, and scalable while providing sensor modality.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for domain adaptation comprising;
obtaining a plurality of tasks from a first domain, the plurality of tasks including at least a first task and a second task,
training a machine learning system to perform the first task;
generating a first set of prototypes associated with a first set of classes of the first task;
optimizing a first loss output that includes a first task loss, the first task loss being computed based on the first set of prototypes;
updating the machine learning system based on the first loss output;
training the machine learning system to perform the second task;
generating a second set of prototypes associated with a second set of classes of the second task;
optimizing a second loss output that includes a second task loss, the second task loss being computed based on the second set of prototypes;
updating the machine learning system based on the second loss output;
obtaining a new task from a second domain; and
fine-tuning the machine learning system with the new task.

2. The computer-implemented method of claim 1, wherein:
the first task includes a first support set and a first query set;
the first set of prototypes is computed using the first support set; and
the first task loss is computed using the first query set.

3. The computer-implemented method of claim 1, wherein:
the second task includes a second support set and a second query set;
the second set of prototypes is computed using the second support set; and
the second task loss is computed using the second query set.

4. The computer-implemented method of claim 1, wherein:
the machine learning system is trained with the first task a first plurality of times; and
the machine learning system is trained with the second task a second plurality of times.

5. The computer-implemented method of claim 1, further comprising:
obtaining sample input data associated with the new task;
generating, via the machine learning system, sample output data in response to the sample input data;
generating an anomaly score for each of the sample input data based on the sample output data; and
indicating whether a particular sample is anomalous when an associated anomaly score differs from an expected value beyond a threshold.

6. The computer-implemented method of claim 1, wherein the step of fine-tuning the machine learning system with the new task comprises:
obtaining a few-shot examples associated with the new task;
generating, via the machine learning system, few-shot output data in response to the few-shot examples;
generating a new set of prototypes associated with a new set of classes of the new task;
optimizing a new loss output that includes a new task loss, the new task loss being based on the new set of prototypes and the few-shot output data; and
updating the machine learning system based on the new loss output.

7. The computer-implemented method of claim 1, further comprising:
computing an outlier loss based on outlier data that does not belong to a normal distribution of the first task,
wherein the first loss output is computed based on the first task loss and the outlier loss.

8. One or more non-transitory computer readable storage media storing computer readable data with instructions that when executed by one or more processors cause the one or more processors to perform a method for domain adaptation that comprises:
obtaining a plurality of tasks from a first domain, the plurality of tasks including at least a first task and a second task,
training a machine learning system to perform the first task;
generating a first set of prototypes associated with a first set of classes of the first task;
optimizing a first loss output that includes a first task loss, the first task loss being computed based on the first set of prototypes;
updating the machine learning system based on the first loss output;
training the machine learning system to perform the second task;
generating a second set of prototypes associated with a second set of classes of the second task;
optimizing a second loss output that includes a second task loss, the second task loss being computed based on the second set of prototypes;
updating the machine learning system based on the second loss output;
obtaining a new task from a second domain; and
fine-tuning the machine learning system with the new task.

9. The one or more non-transitory computer readable storage media of claim 8, wherein:
the first task includes a first support set and a first query set;
the first set of prototypes is generated using the first support set; and
the first task loss is computed using the first query set.

10. The one or more non-transitory computer readable storage media of claim 8, wherein:
the second task includes a second support set and a second query set;
the second set of prototypes is computed using the second support set; and
the second task loss is computed using the second query set.

11. The one or more non-transitory computer readable storage media of claim 8, further comprising:
obtaining sample input data associated with the new task;
generating, via the machine learning system, sample output data in response to the sample input data;
generating an anomaly score for each of the sample output data; and
indicating whether or not each of the sample input data is anomalous or non-anomalous by comparing each anomaly score with a threshold value.

12. The one or more non-transitory computer readable storage media of claim 8, wherein the step of fine-tuning the machine learning system with the new task comprises:
obtaining a few-shot examples associated with the new task;
generating, via the machine learning system, few-shot output data in response to the few-shot examples;
generating a new set of prototypes associated with a new set of classes of the new task;
optimizing a new loss output that includes a new task loss, the new task loss being computed based on the new set of prototypes and the few-shot output data; and
updating the machine learning system based on the new loss output.

13. The one or more non-transitory computer readable storage media of claim 8,
computing a first outlier loss based on outlier data that does not belong to a normal distribution of the first task,
wherein the first loss output includes the first task loss and the first outlier loss.

14. A computer-implemented method for domain adaptation comprising:
obtaining a first task from a plurality of tasks in a source domain, the first task including a first support set and a first query set;
generating, via a machine learning system, first support output in response to the first support set;
generating a first set of prototypes for each class of the first task using the first support output;
generating, via the machine learning system, first query output in response to the first query set;
computing a first loss output that includes at least a first task loss, the first task loss being computed based on the first set of prototypes and the first query output;
updating a parameter of the machine learning system based on the first loss output;
training the machine learning system with respect to remaining tasks of the plurality of tasks; and
fine-tuning the machine learning system with a few-shot examples from a new task in a target domain.

15. The computer-implemented method of claim 14, wherein the step of training the machine learning system with respect to the remaining tasks of the plurality of tasks further comprises:
generating, via the machine learning system, another support output based on another support set;
generating another set of prototypes for each class of another task using the another support output;
generating, via the machine learning system, another query output based on another query set;
computing another loss output, the another loss output including another task loss based on the another set of prototypes and the another query output; and
updating the parameter of the machine learning system based on the another loss output,
wherein the another task includes the another support set and the another query set.

16. The computer-implemented method of claim 14, wherein the step of fine-tuning the machine learning system with the few-shot examples from the new task in the target domain further comprises:
generating, via the machine learning system, few-shot output in response to the few shot examples;
generating new prototypes for each class of the new task using the few-shot output;
computing a new task loss based on the new prototypes and the few-shot output;
updating the parameter of the machine learning system based on the new task loss; and
deploying the machine learning system in the target domain.

17. The computer-implemented method of claim 14, further comprising:
obtaining the new task, the new task including the few-shot examples and samples;
generating, via the machine learning system, sample output data in response to the samples;
generating an anomaly score for each of the samples; and
indicating whether a particular sample is anomalous when an associated anomaly score differs from an expected value beyond a threshold.

18. The computer-implemented method of claim 14, further comprising:
computing an outlier loss based on outlier data that does not belong to a normal distribution of the first task,
wherein the first loss output includes the first task loss and the outlier loss.

19. The computer-implemented method of claim 14, wherein each prototype of the first set of prototypes is a class centroid.

20. The computer-implemented method of claim 14, wherein:
the first task includes first metadata; and
the first task loss is computed using the first metadata as first ground truth data.
